(19) United States
(12) Patent Application Publication
(10) Pub. No.: US 2002/0143558 A1
(43) Pub. Date: Oct. 3, 2002

(54) Funnel effect system and method for a website

(76) Inventor: Michael Joseph, Dublin (IE)

Correspondence Address: YOUNG & THOMPSON, 745 SOUTH 23RD STREET 2ND FLOOR, ARLINGTON, VA, 22202

(21) Appl. No.: 09/809,099

(22) Filed: Mar. 16, 2001

(51) Int. Cl. G06F 7/00

(52) U.S. Cl. 705/1

(57) ABSTRACT

The present invention relates to the field of tourism and travel in general and in particular to an internet based method and system which may be implemented relatively easily yet which is effective particularly in encouraging users to utilise the system. Moreover, the invention relates to cards and card production and provides a card selection system comprising at least one datastore, the at least one datastore storing a plurality of images, a plurality of URL's, and associations between stored images and at least one of the plurality of URL's, a request processor for receiving a user request from a user, and a card menu generator operable in response to said user request and being adapted to assemble a menu of URL's and images for presentation to the user, wherein the menu generator assembles the menu by reference to the stored associations between the stored images and stored URL's.

### FIELD OF THE INVENTION

The present invention relates to the field of tourism and travel in general and in particular to an internet based method and system which may be implemented relatively easily yet which is effective particularly in encouraging users to utilise the system. Moreover, the invention relates to cards and card production.

### BACKGROUND OF THE INVENTION

As the Internet and its usage grow, it is important that web portals are promoted both electronically on the web and using non-internet based methods. In order to create an environment in which it can expand, an Internet business must, in addition to internet based methods, also communicate to the general public through more traditional “non-internet” means such as advertising in the print media and through radio and television broadcasts etc. It is a generally desirable feature for any web portal that potential users be allowed movement that is as seamless and simple as possible to get to the website. A well known technique to achieve this is by selection of an easily remembered web address or URL (Uniform Resource Locator).

Many techniques have been previously employed to try to generate traffic to a given website. These include mailshots both in the electronic and non-electronic forms. Many people find such mail shots even if personalised very intrusive and often resent finding that their home address or e-mail address has been added to a mailing list. Accordingly, there is a need for a method of generating traffic to a website without the creation of such feelings. In particular, it is desirable that people are actually encouraged to visit a website by employing techniques such as those which form part of the present invention.

The present inventor has found a particularly effective method of encouraging visits to a tourism/travel website. The present invention utilises postcards of both the electronic and non-electronic varieties and provides a method for the creation of same. It has been found (by the inventor) that the non-electronic (paper type material, e.g. card) postcard is a particularly effective instrument to employ to generate traffic to a website.

A postcard is sent from a sender to a recipient. Normally, the sender will be a visitor to a certain geographic location and the recipient will normally reside in a different geographic location. The sender will usually be known to the recipient so that the received postcard does not normally create the feeling of intrusion referred to above. Furthermore, the postcard may arouse interest in the geographic location and this interest is not currently being exploited. Furthermore, the recipient may tend to keep the postcard (particularly if it is of the non-electronic variety) further enhancing the value of the postcard as a promoting medium. Postcards received are often prominently displayed for example in the home, at the place of work etc. so that persons other than the recipient may see the postcard and have the same interest in the place visited aroused. The system then becomes a self propagating one as once the initial interest has been stirred and the website visited further visits by the same party or another party may be expected.

Accordingly one aspect of the present invention is to provide a card selection system comprising

(a) a first datastore containing a plurality of images;

(b) a second datastore containing a plurality of URL's;

(c) a third datastore storing associations between images of the first datastore and at least one of a plurality of subject identifiers;

(d) a fourth datastore storing associations between URL's of the second datastore and at least one of a plurality of subject identifiers;

(e) a request processor for receiving a user request from a user, the request processor being adapted to identify a subject identifier from the user request,

(f) a card menu generator adapted to

(i) select images associated with the subject identifier from the first datastore using the associations contained in the third datastore,

(ii) to select URL's associated with the subject identifier from the second datastore using the associations contained in the fourth datastore, and

(iii) to generate a menu of configurable cards for presentation to a user, the menu identifying the selected images and URL's associated with the subject identifier.

The first, second, third and fourth datastores may be implemented as one or more tables in a relational database. The system may comprise selection acceptance means for accepting a image-URL combination selection made by a user from the assembled menu.

The system may further comprise a card configurator adapted to accept the image-URL combination selection made by a user and create a card, the card having represented thereon the image and the URL identified in the accepted image-URL combination. This method for the selection of cards is very useful as for example one or more URL's appropriate to a geographical location may be provided. Accordingly, the card selection system is particularly suitable for postcards.

It has been found by the present inventor that the use of postcards has changed somewhat particularly with the advent of electronic cards often called “e-cards”. Ordinary non-electronic postcards were traditionally made available at a specific geographic location for example postcards showing images of, or otherwise pertaining to New York city would for the main part be sold only in New York city so that the postcard would be sent by a person who obtained the postcard in New York city and who sent the postcard by ordinary mail to someone known to them. The recipient would usually be located in a different geographical region to that from which the postcard is sent. E-cards on the other hand are made available on the Internet and any person who logs into the appropriate website can send an e-card to any other via e-mail. As a result e-cards which are often termed postcards have no geographic or tourist/travel association. Often the e-cards are not postcards in the true traditional sense. Instead the e-card is more like any other e-card and often amounts to no more than an advertisement of for example a website or a company etc. The person receiving the card knows that the card could have been and was sent most likely to them by someone who visited only a website and not any specific geographical location. Such e-cards may at the time of writing be found at the URL www.postcard.com on the Internet.

Accordingly, the present inventor has provided a method for re-establishing for e-postcards the traditional functionality of being sent from a specific location. This may be achieved in broad terms by ensuring that an intended sender of a card pertaining to a specific geographic location is within the geographic area.

In particular the present invention provides a system for making available electronic postcards which pertain to a geographical region comprising:

(i) a first datastore of geographical regions;

(ii) a second datastore of electronic postcards;

(iii) a third datastore storing associations between the geographical regions of the first datastore and the electronic postcards;

(iv) a postcard request processor for receiving a user request from a user, the request processor being adapted to identify from the user request a geographical region from which the user request is being made; and

(v) an electronic postcard menu generator adapted to

(a) select electronic postcards, associated with the geographical region of the user request, from the first datastore using the associations contained in the third datastore,

(b) to generate a menu of electronic postcards for presentation to a user.

The first, second and third datastores may be implemented as one or more tables in a relational database. The system may used together with the system described above to act as both a postcard generation and postcard allocation system. The postcards to be sent, and the geographical regions from which they may be sent, are thus selectable. The postcard will then ostensibly come from a geographical region actually physically visited. Most e-postcards don't give the recipient any information about where the postcard is purported to originate unless of course an image or some such other information such as text is provided to let the user know where the card originates. On a non-electronic postcard the mailing authorities' stamp may be a suitable identifier of the place of origin. As a desirable enhancement to the present invention e-postcards may be additionally marked so as to indicate the geographical region of interest. In one embodiment the e-postcard has incorporated therein a mark which indicates the geographical region of origin. The mark could for example be a specified electronic authentication signature of some form for example one that states the region of origin or one that presents an image associated with the place of origin.

The non-electronic postcards may be offered for sale in the geographical area to which it is associated. If these postcards could be made available at no charge this would further enhance the likelihood of the distribution of the postcards on a wider scale. By recouping the cost of production of the postcards up front for example by selling preprintable advertisement to advertisers this may be achieved. For example the advertisement could take the form of a faded image on the rear (addressing) face of the postcard.

A postcard of plastics material may be more resilient to handling, exposure to the elements etc..

A further aspect of the invention provides a method for generating traffic on the Internet to a website providing tourism and/or travel products and/or services and/or information relating to a plurality of geographic locations, comprising the steps of:

(i) establishing a network of referrer websites and at least one referred website each with an associated URL and each providing tourism and/or travel products and/or services and/or information relating to at least one of said geographic locations either directly on a website at the URL or on a referred website to which the website redirects;

(ii) creating links on the referrer websites for referring traffic to said at least one referred website;

(iii) creating marketing material in the form of electronic or printed postcards; the postcards having displayed prominently thereon at least one URL selected from the URL of the referrer or of the referred websites so as to induce a receiver of the postcard to visit the website located at the domain name;

(iv) inducing propagation of the marketing material by making the postcards available to visitors to said at least one geographic location, or to visitors to said referrer or referred websites for sending to one or more recipients;

(v) maintaining a database for storing information relating to visitors to said referrer or referred websites said visitors including recipients of the postcards.

A postcard comprising:

(i) a display area for display of an image

(ii) a message area for carrying a message

(iii) the postcard having displayed prominently thereon the URL of a tourism or travel website having an associated database comprising a series of unique indicia at least some of which are correlated to one or more prizes; the postcard further comprising:

(iv) at least one indicium from the series of unique indicia associated the postcard in an initially hidden arrangement;

(v) a revealing element associated with the indicium for keeping the indicium hidden until such time as the revealing element is employed, the indicium being checkable on said website against said database to determine if it correlates to a prize.

The postcard may be an electronic one or a non-electronic. When the postcard is a non-electronic one it may take the following form:

A non-electronic postcard comprising:

(i) a flat piece of card having a front face and a rear face

(ii) the rear face having a writing area in which a message may be written

(iii) the front face having displayed prominently thereon the URL of a tourism or travel website having an associated database comprising a series of unique indicia at least some of which are correlated to one or more prizes; the postcard further comprising:

(iv) at least one indicium from the series of unique indicia on the postcard;

(v) an opaque scratch-off panel over the indicium for keeping the indicium hidden until such time as the scratch-off panel is removed, the indicium being checkable on said website against said database to determine if it correlates to a prize.

The prize may take the form of a gift such as a toy or such like. Alternatively the prize can take the form of a monetary amount, a redeemable voucher or some other free or discounted prize such as a travel ticket.

The postcard desirably has an image which pertains to the domain name. The URL may be underlined to assist in conveying the impression that the website corresponding to the URL relates to a tourism/travel website.

For example the unique features of the URL and/or the postcard include that the URL appears prominently on the front, back or front and back of a postcard or greeting card.

The URL placed prominently on the postcard is selected to:

(i) to attract the attention of the tourist (visitor)

(ii) to be interesting enough to the recipient so that the recipient investigates the URL.

One of the main reasons the present invention is successful in attracting visits to a website is the fact that all the integers are tourist/travel related. Coupled to this is the fact that a very high proportion of tourists buy postcards and many of these postcards make their way to recipients in a diverse range of locations. As usage of the Internet and e-mail increases the number of items in the light mail category travelling by terrestrial (often termed “snail” mail) is apparently decreasing. One exception to this general trend is the postcard where apparently the numbers of postcards being transmitted is increasing, thus bucking the overall downward trend.

The senders of postcards have an interest in places and travel and the recipients interest may be aroused particularly where the postcard is evidently from a specified location.

Where the postcard is an electronic one it is desirable that the postcard is actually sent to the recipient. In this respect the recipient can expect to receive the postcard at the appropriate location for example at an email address. Many electronic card providers do not send the e-card directly to the recipient. Instead what the recipient receives is a message that the e-card has been requested and usually it is held on the website for the recipient. The recipient views the card by visiting the appropriate website location usually facilitated for ease of access by the provision of a hyperlink or some such other link in a message to the recipient.

For non-electronic card it may be desirable to have the mailing charges prepaid thus increasing the likelihood that anyone who acquires a postcard will send it by mail.

Where the invention relates to non-electronic postcards the method of the invention can be considered to be a method for facilitating transactions between a plurality of service requesters and at least one service provider, the method comprising the steps of:

(a) maintaining a data base including a set of geographic association attributes, and, for each element of the set of geographic association attributes, at least one related resource identification indicium;

(b) producing a plurality of hard-copy printed media, said media having at least one geographic association attribute and at least one related resource identification indicium thereon;

(c) distributing said hard-copy printed media to first recipients within a geographic area identified by said at least one geographic association attribute;

(d) establishing multiple-path distribution channels for said printed media by constructing said printed media to encourage re-distribution from first recipients to second recipients;

(e) receiving, from at least one of said second recipients, requests for services directed to said at least one service provider identified by said at least one resource identification indicium; and

(f) collecting and storing identification information relating to said second recipients during said requests for services.

In another aspect the present invention provides a method for facilitating transactions between a plurality of service requesters and at least one service provider, the method comprising the steps of:

(a) maintaining a data base including a set of geographic association attributes, and, for each element of the set of geographic association attributes, at least one related resource identification indicium;

(b) providing at least one portal web site maintained by said at least one service provider;

(c) collecting and storing identification information from first service requesters through said at least one portal web site;

(d) sending an electronic postcard to each of said first service requesters, said electronic postcard including at least one element of the set of geographic association attributes and at least one related resource identification indicium;

(e) establishing multiple-path distribution channels for said electronic postcards by configuring said electronic postcards to encourage re-distribution from first service requesters to electronic postcard recipients;

(f) receiving, from at least one of said electronic postcard recipients, requests for services directed to said at least one service provider identified by said at least one resource identification indicium; and

(g) collecting and storing identification information relating to said electronic postcard recipients during said requests for services.

### DESCRIPTION OF DRAWINGS

The invention will now be described in greater detail with reference to the accompanying drawings in which:

FIG. 1 is a schematic representation of a funnel web system using postcards according to a first embodiment of the invention,

FIG. 2 is an example of a method of operation of the system of FIG. 1,

FIG. 3 is an example of a card according to the invention,

FIG. 4 is an example of a system according to a secondary aspect of the invention,

FIG. 5 is a method of operation of the system of FIG. 4,

FIG. 6 is a subset of operation of the method of FIG. 5, and

FIG. 7a, 7b and 7c are illustrations of different aspects of the same card according to a further embodiment of the invention.

### DETAILED DESCRIPTION OF THE INVENTION

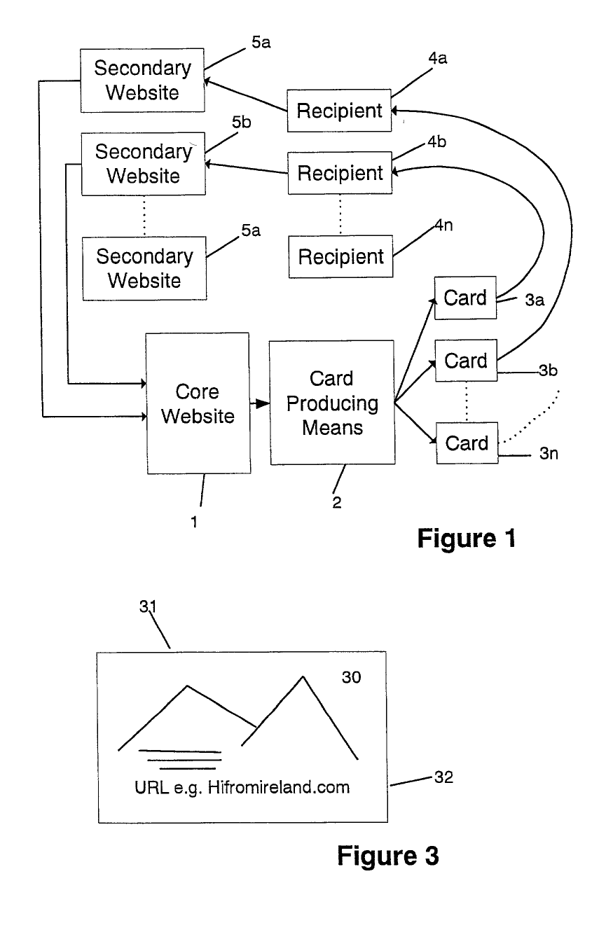

The operation of a first embodiment of the invention, as illustrated in FIG. 1, revolves around a core website 1. The core website 1 is associated with a card producing means 2 for producing one or more cards 3a-n. The produced cards 3a-n may be sent by a user to one or more recipients 4a-n. Each of the produced cards 3a-n identifies a URL for a secondary website 5a-n. Each of the plurality of secondary websites 5a-n refer to the core website 1 or re-direct a user accessing the secondary website 5a-n to the core website 1. It will be appreciated by those skilled in the art that the references to a and n to indicate that a plurality of secondary websites, recipients and cards may exist at anyone time but that the number of recipients cards and URLs are not necessarily the same.

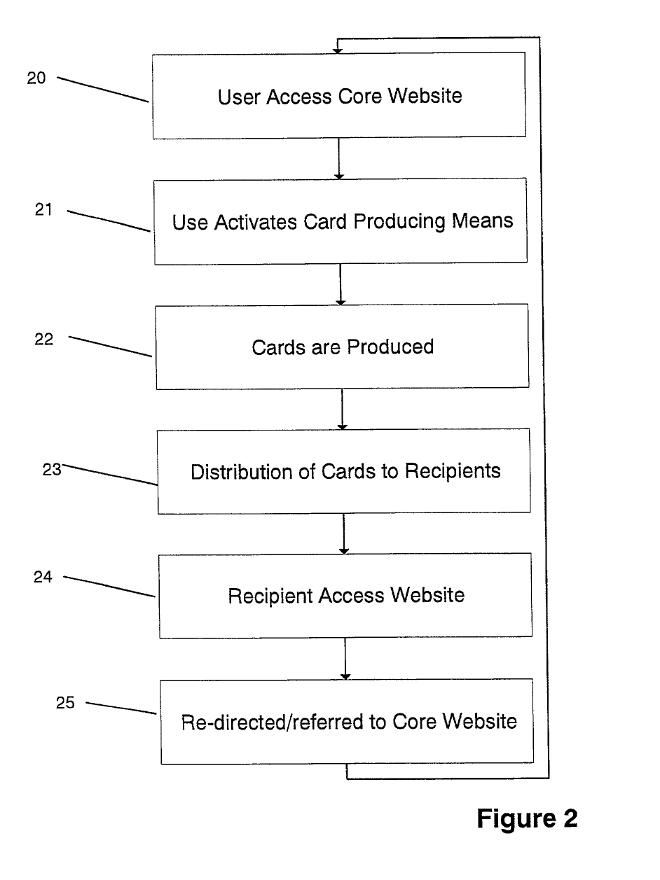

The operation of the system will now be explained with reference to FIG. 2. For ease of explanation, the operation may be taken to commence with a user accessing 20 the core website 1. In response to a user selection, the core website activates 21 the card producing means to produce a card. The URL may be underlined to further emphasis that the URL relates to an every website. The URL can be in red print indicating that the URL has been inserted.

The card producing means 2 facilitates the production 22 of one or more cards 3a-n by a user. An example of a card 3.0 which may be produced by the card producing means 2 is illustrated in FIG. 3 and comprises an area having an image 31 and at least one resource identification indicium (i.e. a URL) 32. The URL should be placed prominently on the card to attract the attention of a person viewing the card.

Preferably, the image 31 of the card 3 is conceptually related to a distinctive part of the URL 32, i.e. the part of the URL which is not a primary domain (e.g. .ie, .uk, com) or secondary domain (e.g. .co(.uk) etc.). More specifically, the distinctive part of the URL should relate to tourism or travel concepts which may for example include a sentiment in combination with the location. Ideally, the URL should be interesting enough to the recipient so that the recipient investigates the website 5a-n identified by the URL.

For example, the image 31 may represent a well known landmark in a country (e.g. Ireland) or a image associable with a country. Whereas the URL 32 may relate to a sentiment combined with country, country adjective or country symbol e.g. www.goodluckfromireland.com, www.highfromamsterdam.com, www.bahamabummin.com, www.whenirisheyessmile.com, www.parisinspring.com, www.londonbridgefelldown.com, www.passionateparis.com, www.irishgirlsarenice.com, www.heyforgetaboutit.com (Hey forget about it—relates to New York), www.aunionjack.com (a Union Jack), www.akgbsecret.com (a KGB secret).

Moreover, the URL 32 on the card may simply represent common tourist sentiments, e.g. www.ilovetotravel.com (I love to travel), www.iammissingyou.com (I am missing you), www.wishyouwerewithus.com (wish you were with us), www.iloveithere.com (I love it here), www.iwasthinkingofyou.com (I was thinking of you) or www.irishgirlsarenice.com (Irish girls are nice). In these cases, the image 31 may be representative of the sentiment expressed in the URL 32.

Similarly, The URL 32 may express the sentiment of the image 31 or images on the front of the postcard, e.g. www.pintafterpint.com (pint after pint) where the image could be of many pints of lager or stout on a bar, www.itrainedandrained.com (it rained and rained) where the image may be of a stunning rainstorm in the distance of the plains in Africa, www.irishgirlsarenice.com (Irish girls are nice) where the image could be of two or more Irish girls after a night of heavy partying, wwwjustbumminaround.com Oust bumming around) where the image 31 could be of several attractive female bodies sunbathing or www.exposeyourselftoireland.com (expose yourself to Ireland) where the image 31 could be of a man or woman opening their coat (as if flashing) to a flock of sheep in the setting of the Irish country side.

In a further embodiment, the URL 32 may be representative of an invitation to enter a competition to win a prize such as a travel prize. Examples of such URL's may include www.winatriptoseeme.com (win a trip to see me), checkseeandflytome.com (check see and fly to me), www.hereisyourchance.com (here is your chance), www.postcardtickets.com (postcard tickets) or www.mightbeafreetrip.com (might be a free trip). In this scenario, the image 31 may for example be representative of the prize available or of a person celebrating winning a prize.

The URL is preferably not the name of an established company, for example, www.aer-lingus.com, www.guinness.com and www.expedia.com.

It will be appreciated that although Ireland is used in this example the present invention may be used in respect of any country for example, www.ausomeaustralia.com for Australia.

One main way in ensuring the arousal of the interest of the recipient 4a-n of the postcard is to employ a URL 32 which does not immediately suggest that the website 5a-n which may be found at the URL sells products e.g. watch.com, telephone.com, etc.

Instead the URL 32 desirably is an expression and will therefore comprise more than one word and often two to eight such as three to seven words. The present inventor has found that the URL 32 itself and/or an accompanying message if somewhat tongue-in-cheek attracts the interest of the recipient to a greater extent. In a preferred configuration an image 31 on the postcard and the URL 32 are related so that there is a correlation between the image 31 and the URL 32. The URL 32 is thus more memorable as it is remembered in conjunction with the image 31.

The card producing means 2 may produce electronic (e-cards) and/or traditional types of paper based cards. Paper based cards may be produced by suitable printing means either individually or in batches. Distribution of the cards 3a-n may be effected either by electronic means using techniques well known in the art of e-cards or by conventional means such as the postal services for non electronic cards.

Each user may distribute one or more cards 3a-n to one or more recipients 4a-n. In fact, the more recipients 4a-n a user sends cards to the better as the principle purpose of the cards is to generate web traffic to the core website 1.

Upon receipt by a recipient 4a-n of a card 3a-n, a recipient 4a-n may access the secondary website 5a-n having the URL 32 identified on the card received. Upon accessing the secondary website 5a-n, a referral system will re-direct the recipient to the core website. In this way the referral system will move the recipient from the secondary website 5a-n to the core website 1. Once at the core website 1, the process may re-commence with the recipient 4a-n now becoming a user who can send cards 3a-n.

Typically, each user will send cards to more than one recipient. As the sender will usually be known to the recipient, the card sent will not create the feeling of intrusion referred to above. Furthermore the system becomes self propagating once an initial interest has been stirred. In this respect an initial interest could be generated by the pre-printing of a plurality of printed postcards 3a-n. Each postcard having thereon printed a URL 32 corresponding to one of the URLs the secondary websites 5a-n. It is suggested that by using this technique exponential growth in the use of the core website may be achieved. As the users are being directed to websites having interesting URL's names, they are more likely to be attracted to view the secondary website than they would if simply the URL of the core website had been included. A trial by the present inventor with an initial distribution of 500 pre-printed postcards resulted in how many hits on the website. In this way, the system may best be described as a funnel system with the large number of secondary websites 5a-n forming the opening to a funnel with the core website 1 forming the exit.

Before operation of the system may be commenced it will be necessary to establish multiple websites 5a-n having URLs which relate to tourism or travel concepts as previously described above.

Preferably configuration an image on the postcard and the URL are related so that there is a correlation between the image and the URL. The URL is thus more memorable as it is remembered in conjunction with the image.

In addition the image should preferably relate to the domain name in some way so as to further increase the recipients interest. A significant disadvantage of limiting only one URL with one image or vice versa is that either the user is presented with a limited choice of cards from which to select a card or a system must be established with a very large number of secondary websites 5a-n. To establish such a large number of secondary websites would be expensive. It will be appreciated however, that an image may be suitable for several URLs or that an URL may be suitable for several different images.

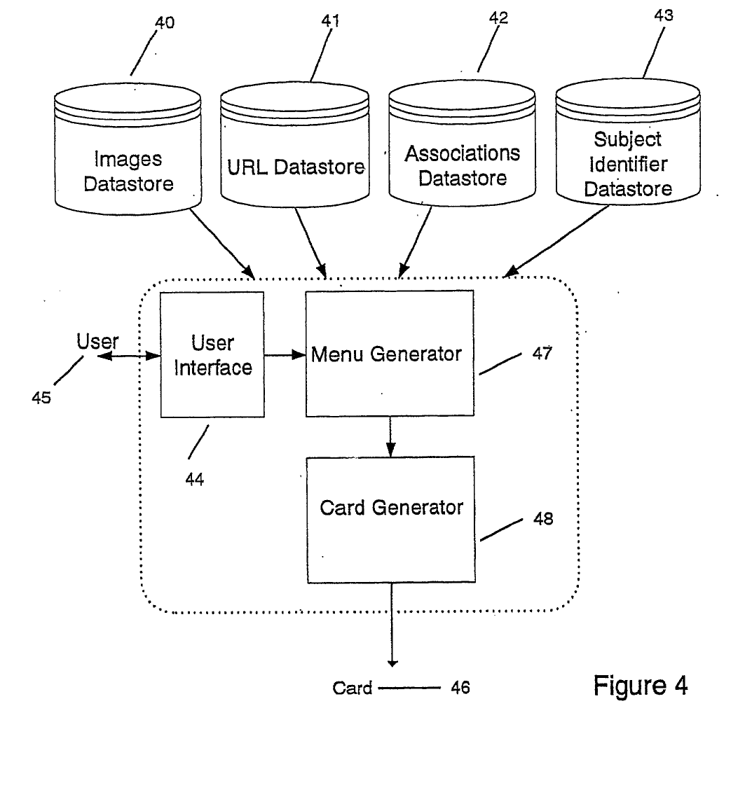

Accordingly, the invention further provides for a system for the production of cards which overcomes this disadvantage. The system provides, as illustrated in FIG. 4, a first data store 40 containing a plurality of images, a second data store 41 containing a plurality of URLs, each URL identifying a secondary website and a third datastore 42 containing a list of associations between individual images of the first data store and individual URLs identified in the second data store.

Optionally a fourth data store 43 may be provided comprising a list of locations, a list of subjects and URLs associated with those subjects.

The system also provides for a user interface 44 to permit a user 45 to interact with the system to produce one or more cards 46. The overall control and production of cards by the system is performed by a menu generator 47 acting in combination with a card generator 48. In response to a user request, the menu generator 47 identifies available locations, images and/or URLs and presents these to a user 45 in a menu or other suitable form. The menu means is adapted to receive requests from the user interface in response to one or more menus generated by the menu generator 47.

A card generator is provided which is adapted to produce cards in response to requests received by the menu means from a user. The card generation means comprises means for retrieving an image and a URL from the respective data stores corresponding to information contained in the user request and assembling these into and generating a card. It will be appreciated by those skilled in the art that a plurality of techniques may be used to implement the data stores, user interface, menu means and card generator.

For example, the data stores may be implemented as a relational database, for example SQL, having one or more tables, i.e. the datastores may be combined in a single table or separated in different tables. Whereas, the menu generator, user interface and card generation means may be implemented as Common Gateway Interface (CGI) executable programs using techniques well known to those skilled in the art.

Preferably, the URL on a card should be co-located with a section of the image on the card. In the case of electronic cards this may be achieved using image merging software which may be sued to superimpose the text of the URL on to the image to produce a resultant image having text superimposed on it.

This resultant image may be used for printing paper based cards. Alternatively, the URL may be printed as an overlayer, i.e. printed on a paper card after the image has been printed.

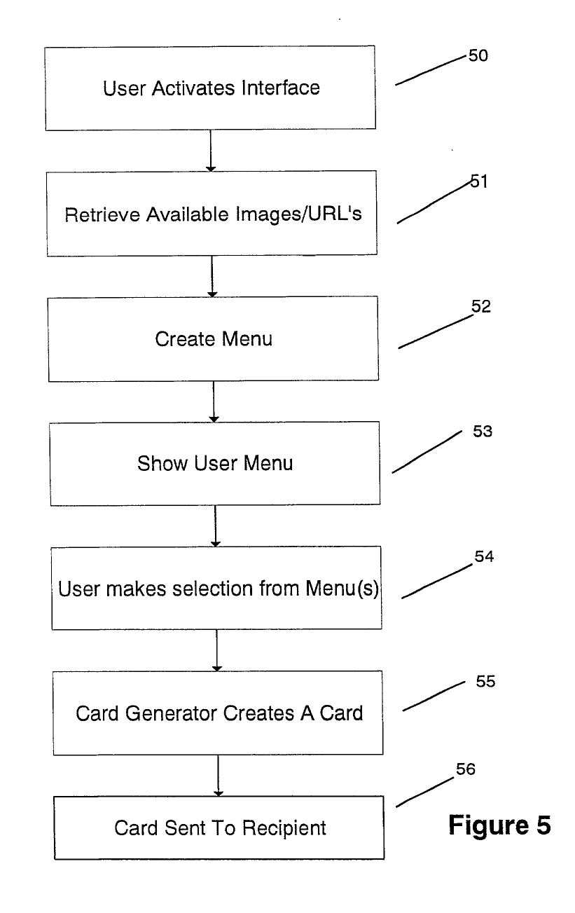

The card producing system, as illustrated in FIG. 4, will be better understood by reference to the exemplary method of operation shown in FIG. 5.

The exemplary method is activated by a user accessing the system using the user interface, for example perhaps by using a web browser to access a web page of the system. In response to this activation, the menu generator retrieves available images and/or URL's and creates a menu of available images and URL's for presentation to the user. The user may make a selection identifying an image and an associated URL from the generated menu via the user interface, i.e. the user may be presented with a web page showing them available images and URL's. The user may also be asked for details of the person to whom the card is to be sent, for example the persons name, street address, e-mail address etc.. They may also be requested to enter a message for the person they are sending the card to.

The user selection is passed to the card generator which in response creates a card corresponding to the user selection. This card 3a-n may be either electronic i.e. an e-card or a paper version. This card may then be sent by the user to the recipient. The system may for example be implemented as a standalone kiosk having a graphical user interface for presenting the user with available images and URL's, a series of datastores (40, 41, 42, 43) for storing the available images and URL's and the card generator 48 may comprise a printing device for printing paper type postcards.

In the case of an electronic card it will be appreciated that the card generator 48 may use conventional techniques known in the art to send the card to a recipient e.g. by embedding the card into an e-mail to the recipient or by sending an e-mail to the recipient notifying them that they may collect their card from a web site.

It will be appreciated that a plurality of different methods may be used to generate the menu and that a variety of different menu systems could be applied depending on the configuration of the system.

For example, in a first method a menu could be used which would present the user with the plurality of URL's available from which the user may select one URL. In response to this selection the menu generator could access the associations data store to identify which images are linked (have an association) to the selected URL. Images associated with the selected URL may then be presented to the user in a second menu. Upon selection by the user of an associated image, the first user selection (the selected URL) and the second user selection (the selected associated image) may be passed to the card generator to generate a card. This method of operation may for example be effected by having a drop down box in a graphical user interface (e.g. a web page) listing a plurality of available URL's, the selection of one of URL's from the drop down box by a user causing the retrieval of a plurality of images associated with that URL to be displayed in an adjacent window of the graphical user interface (e.g. in thumbnail fashion).

In an alternative method of operation the user may first be presented with a series of available images. Upon the selection of an image, the menu generator may access the associations 42 data store to retrieve a list of available URL's which are associated with the selected image. The retrieved list of available URL's may then be presented to the user, to allow the user to make a selection.

Other methods of presentation of available URL's and/or images will be apparent to those skilled in the art without requiring inventive activity.

Although this method may be suitable for operation in a single location e.g. Ireland. It will be appreciated that greater efficiency may be achieved in respect of the images and URL's if the images and/or URL's may be used for more than one location. A problem with this approach is that not all images and/or URL's will be suitable for all locations. For example, while the URL www.wishyouwerehere.com (wish you were here) could be used for all locations, the URL www.greetingsfromireland.com (greetings from Ireland) could not be. Similarly, an image of an Irish landmark could not be used for cards identifying locations other than Ireland, however a generic sunset over the sea could be used for most locations (apart from perhaps landlocked regions).

To achieve this, a subject identifier data store is provide which may be used in combination with the menu generator. The subject identifier data store defines available subject categories, which may be a series of locations, e.g. Ireland, France, USA etc. In addition, the subject identifier datastore may have sub categories for identifying types of images and/or URL's e.g. humorous subject matter, risque subject matter etc. Accordingly, the option may be provided to allow a user to view a menu to select images/URL's matching a particular subject before selecting an individual image and/or URL.

The invention further provides a method for re-establishing for e-postcards the traditional functionality of being sent a card from a specific location. This may be achieved in broad terms by ensuring that an intended sender of a card pertaining to a specific geographic location is within the geographic area.

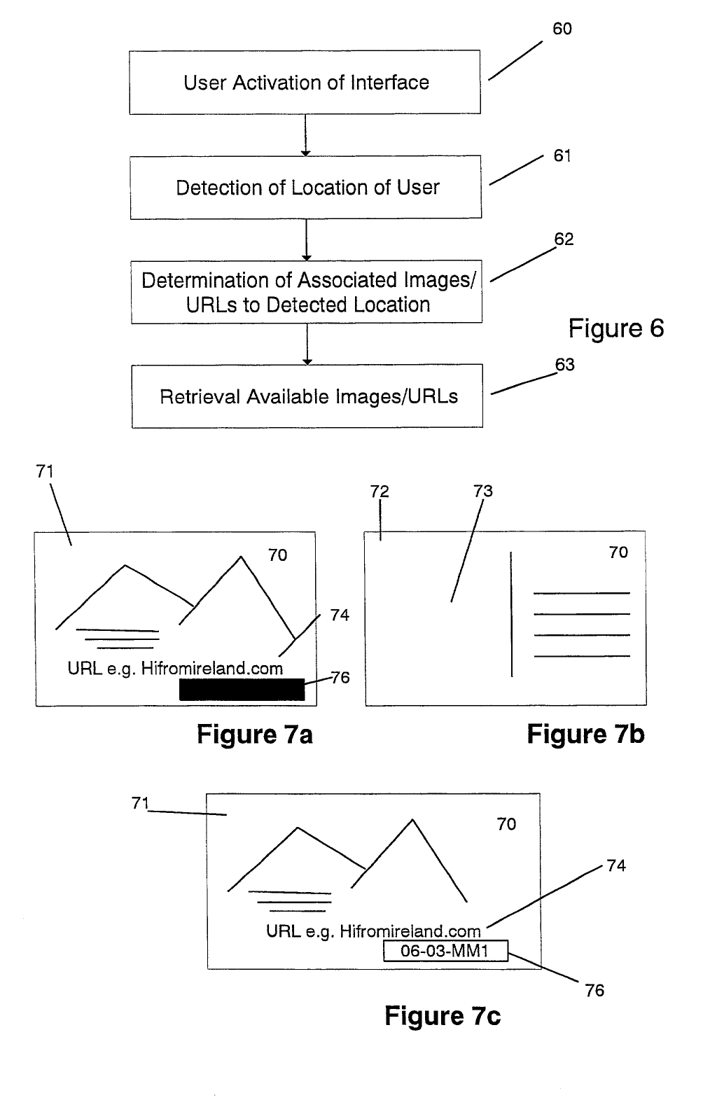

In particular a method is provided using the subject identifier datastore which would contains a series of locations and associated images and/or URL's. The method commences, as shown in FIG. 6, with activation 60 by a user of the user interface. The system, e.g. the user interface, identifies 61 a location for the user from their activation requests or by other means.

Several method of detection of the user's location may be used. For example, if the user interface comprises a web interface then the identification of the user location may be obtained from the originating server primary domain name of the user. For example if the primary domain of the server which the user has accessed the system is .ie, then it will be appreciated that the user has come from a domain name representing Ireland. Accordingly, the user's location may be identified or assumed as Ireland. Other techniques may also be used, for example in a web based environment, a Java script may be included in the web page including the interface to determine the country code defined in the system file of the computer.

If the user interface is a custom terminal, (e.g. the above described kiosk) then the terminal itself may identify the location. After detection of the location, the menu generator means retrieves associated images and/or URLs from the subject identifier data store corresponding to the detected location. It will be appreciated for the kiosk version that having the datastores stored in a location distinct from the kiosk but accessible over a network (e.g. the interet) allows the central maintenance of the available images/locations and/or URL's.

Once the determination of a users location has been made, the system selects (Step 62) available images and/or URLs for that location and the menu generator subsequently retrieves (Step 63) the image/URLs and operates in a manner similar to that described above.

A significant advantage of this latter approach is that as the number of locations is increased, a corresponding increase in the number of images and/or URL's required to add corresponding numbers of images and/or URL's to maintain a large selection of images and/or URL's for users is reduced.

A further aspect of the invention allows recipients to participate in competitions (to enhance participation rates). This further aspect uses a card comprising a display area for the displaying of an image, a message area for carrying a message, a URL, at least one indicium from a series of unique indicia initially s bidden, a revealing element associated with the indicia for keeping the indicium bidden until such time as the revealing element is employed.

The recipient upon receipt of this card may employ the revealing element to reveal the indicium and access the website identified by the URL to determine if the indicium correlates to a prize. The non electronic postcard suitable for implementing this aspect of the invention may comprise, as illustrated in FIG. 7a-7c, a flat piece of card 70 having a front face 71 and a rear face 72. The rear face having a writing area 73 in which a message may be written, the front face having displayed promptly thereon the URL 74 of a website. The server corresponding to the displayed URL 74 having an associated database in which are stored a series of unique indicia, at least some of which are correlated to one or more prizes.

The postcard further comprising at least one indicium from the series of unique indicia stored in the associated database and an opaque scratch off panel 75 over the indicium keeping the indicium hidden. Scratching off the panel reveals the indicium 76. In this method the prize may take the form of a gift such as a toy or such like. Alternatively, the prize can take the form of a monitory amount, a redeemable voucher or some other free or discounted prize such as a travel ticket. The opaque scratch off panel, the indicium along with other conventional aspects found on postcards (e.g. address lines) may be pre-printed on the cards with the card producing means adding an image and/or URL.

Alternatively, a batch of postcards may be pre-printed and distributed. In this case, the selection means described above will not be required. The use of such cards may be useful to generate initial web traffic when launching a website.

For non-electronic cards, it would be desirable to have the mailing charges prepaid thus increasing the likelihood that anyone who acquires a postcard will send it by mail. The non-electronic postcards may be offered for sale in the geographical area to which it is associated. If these postcards could be made available at no charge this would further enhance the likelihood of the distribution of the postcards on a wider scale. By recouping the cost of production of the postcards up front for example by selling preprintable advertisement to advertisers this may be achieved. For example the advertisement could take the form of a faded image on the rear (addressing) face of the postcard.

For the website operator a secondary advantage apart from web traffic may be achieved or obtained from the collection of user and recipient information which may be used in a subsequent marketing campaign to target specific users. For example users who would send cards from Ireland may subsequently be targeted for the sale or of holidays to Ireland.

One of the main reasons the present invention is successful in attracting visits to a website is the fact that all the integers are tourist/travel related. Accordingly, the recipients interest may be aroused particularly where the postcard is evidently from a specified location. Coupled to this is the fact that a very high proportion of tourists buy postcards and many of these postcards make their way to recipients in a diverse range of locations. As usage of the Internet and e-mail increases the number of items in the light mail category travelling by terrestrial (often termed “snail” mail) is apparently decreasing. One exception to this general trend is the postcard where apparently the numbers of postcards being transmitted is increasing bucking the overall downward trend.

From the foregoing it will be apparent that numerous modifications and variations can be effected without departing from the true spirit and scope of the novel concept of the present invention. It will be appreciated therefore that the present disclosure is intended to set forth exemplifications of the invention which are intended to limit the invention to the specific embodiments illustrated. The disclosure is intended to cover by the appended claims all such modifications as fall within the scope of the invention.

The words “comprises/comprising” and the words “having/including” when used herein with reference to the present invention are used to specify the presence of stated features, integers, steps or components but does not preclude the presence or addition of one or more other features, integers, steps or components thereof.

1. A card selection system comprising
(a) at least one datastore, the at least one datastore storing a plurality of images, a plurality of URL's, and associations between stored images and at least one of the plurality of URL's
(b) a request processor for receiving a user request from a user,
(c) a card menu generator operable in response to said user request and being adapted to assemble a menu of URL's and images for presentation to the user, wherein the menu generator assembles the menu by reference to the stored associations between the stored images and stored URL's.

2. A card selection system according to claim 1, wherein the plurality of images are is stored in a first datastore, the plurality of URL's are stored in the second datastore and the associations between images of the first datastore and the URL's of the second datastore are stored in a third datastore;

3. A card selection system according to claim 2, wherein the first, second and third datastores are implemented as one or more tables in a relational database.

4. A card selection system according to claim 1, wherein the at least one datastore stores associations between stored images and at least one of a plurality of subject identifiers, the request processor is adapted to identify a subject identifier from the user request, and the menu generator assembles a menu for presentation to the user, the menu containing image's associated with the subject identifier identified by the request processor.

5. A card selection system according to claim 1, wherein the at least one datastore stores associations between stored URL's and at least one of a plurality of subject identifiers, the request processor is adapted to identify a subject identifier from the user request, and the menu generator assembles a menu for presentation to the user, the menu containing URL's associated with the subject identifier identified by the request processor.

6. A card selection system according to claim 1, wherein the menu generator is adapted to accept a user selection of an image-URL combination selected by a user from the assembled menu.

7. A card selection system according to claim 5, wherein the subject identifiers relate to geographical locations.

8. A card production system having the card selection system according to claim 7, comprising a card generator for creating a card configurator in response to the image-URL combination selection made by a user, wherein the created card has represented thereon the image and the URL identified in the accepted image-URL combination.

9. A system for making available electronic postcards which pertain to a geographical region comprising:
(i) a first datastore of geographical regions;
(ii) a second datastore of electronic postcards
(iii) a third datastore storing associations between the geographical regions of the first datastore and the electronic postcards;
(iv) a postcard request processor for receiving a user request from a user, the request processor being adapted to identify from the user request a geographical region from which the user request is being made
(v) an electronic postcard menu generator adapted to
(a) select electronic postcards, associated with the geographical region of the user request, from the first datastore using the associations contained in the third datastore,
(b) to generate a menu of electronic postcards for presentation to a user.

10. A method for generating traffic on the Internet to a website providing tourism and/or travel products and/or services and/or information relating to a plurality of geographic locations, comprising the steps of:
(i) establishing a network of referrer websites and at least one referred website each with an associated URL and each providing tourism and/or travel products and/or services and/or information relating to at least one of said geographic locations either directly on a website at the URL or on a referred website to which the website redirects;
(ii) creating links on the referrer websites for referring traffic to said at least one referred website;
(iii) creating marketing material in the form of electronic or printed postcards; the postcards having displayed prominently thereon at least one URL selected from the URL of the referrer or of the referred websites so as to induce a receiver of the postcard to visit the website located at the domain name;
(iv) inducing propagation of the marketing material by making the postcards available to visitors to said at least one geographic location, or to visitors to said referrer or referred websites for sending to one or more recipients;
(v) maintaining a database for storing information relating to visitors to said referrer or referred websites said visitors including recipients of the postcards.

11. A postcard comprising:
(i) a display area for display of an image
(ii) a message area for carrying a message
(iii) the postcard having displayed prominently thereon the URL of a tourism or travel website having an associated database comprising a series of unique indicia at least some of which are correlated to one or more prizes; the postcard further comprising:
(iv) at least one indicium from the series of unique indicia associated the postcard in an initially hidden arrangement;
(v) a revealing element associated with the indicium for keeping the indicium hidden until such time as the revealing element is employed, the indicium being checkable on said website against said database to determine if it correlates to a prize.

12. A non-electronic postcard according to claim 11, wherein the postcard is a nonelectronic postcard comprising:
a flat piece of card having a front face and a rear face wherein,
(ii) the rear face having the message area comprising a writing area in which a message may be written;
(iii) the front face having the display area and the revealing element is an opaque scratch-off panel over the indicium for keeping the indicium hidden until such time as the scratch-off panel is removed, the indicium being checkable on said website against said database to determine if it correlates to a prize.

13. A method for facilitating transactions between a plurality of service requesters and at least one service provider using non-electronic postcards, the method comprising the steps of:
(a) maintaining a data base including a set of geographic association attributes, and, for each element of the set of geographic association attributes, at least one related resource identification indicium;
(b) producing a plurality of hard-copy printed media, said media having at least one geographic association attribute and at least one related resource identification indicium thereon;
(c) distributing said hard-copy printed media to first recipients within a geographic area identified by said at least one geographic association attribute;
(d) establishing multiple-path distribution channels for said printed media by constructing said printed media to encourage re-distribution from first recipients to second recipients;
(e) receiving, from at least one of said second recipients, requests for services directed to said at least one service provider identified by said at least one resource identification indicium; and
(f) collecting and storing identification information relating to said second recipients during said requests for services.

14. A method for facilitating transactions between a plurality of service requesters and at least one service provider, the method comprising the steps of:
(a) maintaining a data base including a set of geographic association attributes, and, for each element of the set of geographic association attributes, at least one related resource identification indicium;
(b) providing at least one portal web site maintained by said at least one service provider;
(c) collecting and storing identification information from first service requesters through said at least one portal web site;
(d) sending an electronic postcard to each of said first service requesters, said electronic postcard including at least one element of the set of geographic association attributes and at least one related resource identification indicium;
(e) establishing multiple-path distribution channels for said electronic postcards by configuring said electronic postcards to encourage re-distribution from first service requesters to electronic postcard recipients;
(f) receiving, from at least one of said electronic postcard recipients, requests for services directed to said at least one service provider identified by said at least one resource identification indicium; and
(g) collecting and storing identification information relating to said electronic postcard recipients during said requests for services.
